(19) United States
(12) Patent Application Publication
(10) Pub. No.: US 2022/0097566 A1
(43) Pub. Date: Mar. 31, 2022

(54) Cell Balancing Device

(71) Applicant: Marelli Corporation, Saitama-shi, Saitama (JP)

(72) Inventors: Junya Tanaka, Saitama-shi, Saitama (JP); Naotaka Kumagai, Saitama-shi, Saitama (JP)

(21) Appl. No.: 17/310,403

(22) PCT Filed: Dec. 9, 2019
(86) PCT No.: PCT/JP2019/048145

§ 371 Date: Jul. 30, 2021

(30) Foreign Application Priority Data
Jan. 31, 2019 (JP) 2019-016403

(51) Int. Cl. B60L 58/22; H01M 10/42

(52) U.S. Cl. CPC B60L 58/22; H01M 2220/20; H01M 2010/4271; H01M 10/4257

(57) ABSTRACT

A cell balancing device comprises: a capacity adjustment circuit including a plurality of pairs of series-connected switch elements and resistors connected in parallel with respective battery cells, and configured to adjust respective capacities of the battery cells; a processor; and a watchdog unit configured to monitor the processor, and reset the processor in the case where the processor is abnormal. The processor is configured to: transition to a sleep state when an ignition of a vehicle is turned off, and, in the sleep state, control the switch elements to adjust the capacities of the battery cells; and, when adjusting the capacities of the battery cells, limit the number of simultaneously discharged battery cells to a predetermined number so that a current flowing to the processor is less than a predetermined value.

### CROSS REFERENCE TO RELATED APPLICATION

This application claims priority to and the benefit of Japanese Patent Application No. 2019-016403 filed on Jan. 31, 2019, the entire disclosure of which is incorporated herein by reference.

### TECHNICAL FIELD

The present disclosure relates to a cell balancing device.

### BACKGROUND

A battery pack installed in a vehicle such as a hybrid vehicle includes a plurality of battery cells connected to each other. If the capacities of the battery cells in the battery pack are significantly different, there is a possibility that, when charging the battery pack, a battery cell having a large capacity is overcharged. It is therefore desirable to adjust the capacities of the battery cells in the battery pack to be approximately uniform.

For example, PTL 1 discloses a control circuit that adjusts the capacity of each battery cell in a battery pack even after the charge/discharge of the battery pack ends.

### CITATION LIST

### Patent Literature

PTL 1: JP 3991620 B2

### SUMMARY

In the case of performing cell balancing control that involves adjusting the capacity of each battery cell after the charge/discharge of the battery pack ends, that is, when the ignition of the vehicle is off, it is desirable to execute the cell balancing control in a state in which current consumption is reduced.

It could therefore be helpful to provide a cell balancing device capable of executing cell balancing control in a state of reduced current consumption when the ignition is off.

### SUMMARY

A cell balancing device according to a first aspect is a cell balancing device that performs cell balancing control for a battery pack including a plurality of battery cells connected in series, the cell balancing device comprising: a capacity adjustment circuit including a plurality of pairs of series-connected switch elements and resistors that are connected in parallel with the respective plurality of battery cells, and configured to discharge the battery cells to adjust respective capacities of the battery cells; a processor configured to control the switch elements; and a watchdog unit configured to monitor the processor and, in the case where the processor is abnormal, reset the processor, and stop monitoring the processor in the case where a current flowing to the processor is less than a predetermined value, wherein the processor is configured to transition to a sleep state when an ignition of a vehicle having the cell balancing device installed therein is turned off, and, in the sleep state, control the switch elements to adjust the respective capacities of the battery cells, and the processor is configured to, when adjusting the respective capacities of the battery cells, limit the number of simultaneously discharged battery cells to a predetermined number so that the current flowing to the processor is less than the predetermined value.

The cell balancing device according to the first aspect is capable of executing cell balancing control in a state of reduced current consumption when the ignition is off.

### BRIEF DESCRIPTION OF THE DRAWINGS

In the accompanying drawings:

FIG. 1 is a block diagram illustrating an example of the structures of a battery device and a cell balancing device according to one of the disclosed embodiments;

FIG. 2 is a diagram explaining the operation of a current detection circuit in FIG. 1;

FIG. 3 is a diagram illustrating an example of the relationship between the voltage and the SOC of a battery cell;

FIG. 4A is a flowchart illustrating an example of the timing of cell balancing control by the cell balancing device according to one of the disclosed embodiments in a normal state;

FIG. 4B is a flowchart illustrating an example of the timing of cell balancing control by the cell balancing device according to one of the disclosed embodiments in a sleep state;

FIG. 5 is a flowchart illustrating an example of the procedure of cell balancing control by the cell balancing device according to one of the disclosed embodiments;

FIG. 6A is a diagram explaining an example of the procedure of cell balancing control by the cell balancing device according to one of the disclosed embodiments;

FIG. 6B is a diagram explaining an example of the procedure of cell balancing control by the cell balancing device according to one of the disclosed embodiments;

FIG. 6C is a diagram explaining an example of the procedure of cell balancing control by the cell balancing device according to one of the disclosed embodiments;

FIG. 6D is a diagram explaining an example of the procedure of cell balancing control by the cell balancing device according to one of the disclosed embodiments;

FIG. 7 is a flowchart illustrating another example of the timing of cell balancing control; and

FIG. 8 is a perspective view illustrating the battery device according to one of the disclosed embodiments.

### DETAILED DESCRIPTION

One of the disclosed embodiments will be described below, with reference to the drawings.

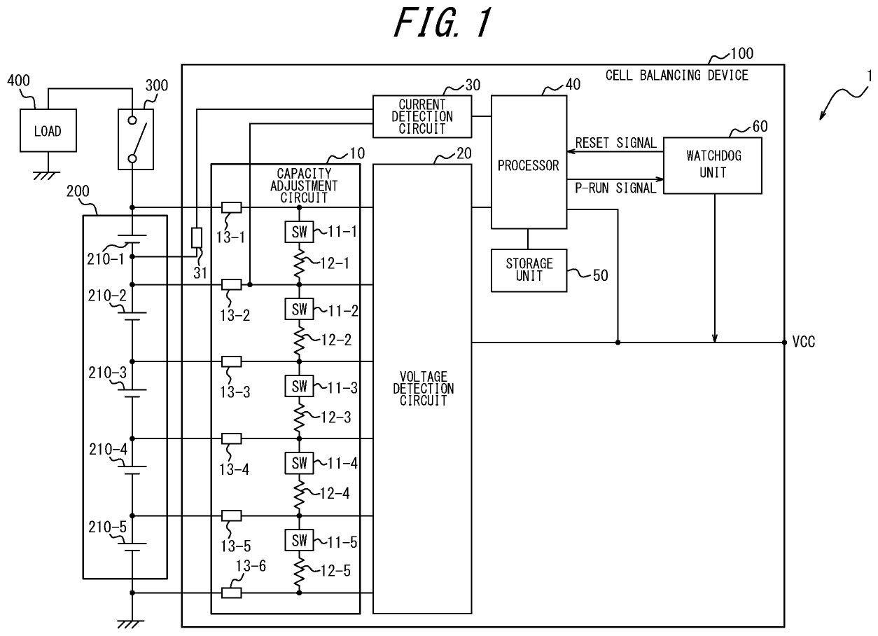

FIG. 1 is a block diagram illustrating an example of the structures of a battery device 1 and a cell balancing device 100 according to one of the disclosed embodiments. The battery device 1 includes the cell balancing device 100, a battery pack 200, and a relay 300. The cell balancing device 100 is connected to the battery pack 200. The cell balancing device 100 performs cell balancing control for the battery pack 200. Herein, the term “cell balancing control” denotes control to adjust the capacities of battery cells 210-1 to 210-5 included in the battery pack 200 so as to be approximately uniform. The cell balancing control will be described in detail later.

The cell balancing device 100, the battery pack 200, the relay 300, and a load 400 illustrated in FIG. 1 may be installed in a vehicle, such as a vehicle including an internal combustion engine such as a gasoline engine or a diesel engine or a hybrid vehicle capable of running with power of both an internal combustion engine and an electric motor.

The battery pack 200 includes a plurality of battery cells 210-1 to 210-5 connected in series. Hereafter, the battery cells 210-1 to 210-5 are also simply referred to as “battery cells 210” unless they need to be distinguished from each other. Although the battery pack 200 includes five battery cells 210-1 to 210-5 in FIG. 1, the number of battery cells 210 included in the battery pack 200 is not limited to five. The battery pack 200 may include any number of two or more battery cells 210.

The battery pack 200 can supply power to the load 400. The battery pack 200 can be charged by regeneration, for example, during deceleration of the vehicle having the cell balancing device 100 installed therein. The battery pack 200 may be chargeable by a commercial AC power source.

Each battery cell 210 may be a secondary battery. For example, the battery cell 210 is a lithium ion battery or a nickel hydride battery. The battery cell 210 is, however, not limited to such, and may be any other secondary battery. The battery cell 210 in this embodiment is 2.4 V, but is not limited to such.

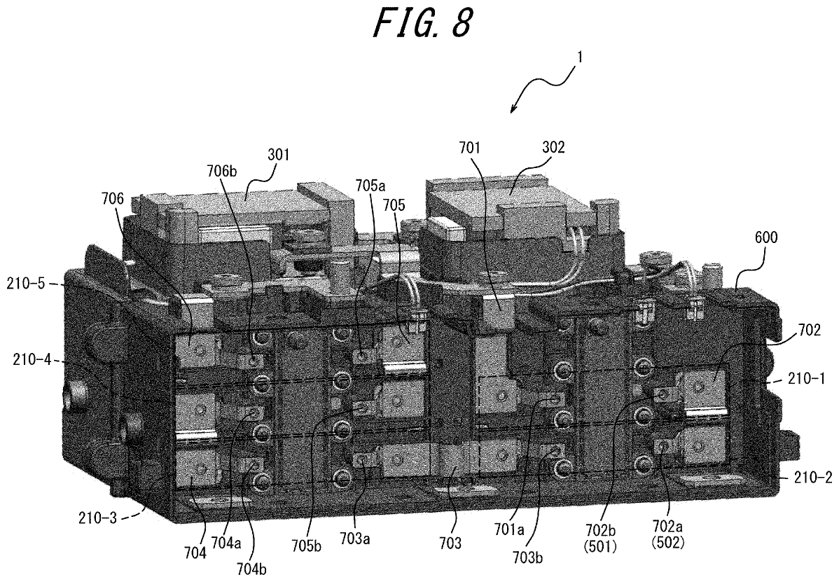

The relay 300 is connected between the battery pack 200 and the load 400. The relay 300 switches the connection between the battery pack 200 and the load 400. When the ignition of the vehicle having the cell balancing device 100 installed therein is on, the relay 300 is controlled to be on by the cell balancing device 100. When the ignition of the vehicle having the cell balancing device 100 installed therein is off, the relay 300 is controlled to be off by the cell balancing device 100. In this embodiment, the relay 300 includes relays 301 and 302 connected in series (see FIG. 8).

The load 400 is any of various electric devices installed in the vehicle having the cell balancing device 100 installed therein. The load 400 can operate when supplied with power from the battery pack 200.

The cell balancing device 100 includes a capacity adjustment circuit 10, a voltage detection circuit 20, a current detection circuit 30, a processor 40, a storage unit 50, and a watchdog unit 60.

The capacity adjustment circuit 10 can adjust the capacities of the battery cells 210-1 to 210-5 by discharging the battery cells 210-1 to 210-5 independently of one another. The capacity adjustment circuit 10 includes switch elements 11-1 to 11-5, resistors 12-1 to 12-5, and chip beads 13-1 to 13-6. In FIG. 1, the switch elements 11-1 to 11-5 are designated as “SW”.

The switch element 11-1 and the resistor 12-1 are connected in series. The switch element 11-1 and the resistor 12-1 connected in series are connected in parallel with the battery cell 210-1. The switch element 11-1 is controlled by the processor 40. When the switch element 11-1 is controlled to be on, the battery cell 210-1 is discharged through the switch element 11-1 and the resistor 12-1. When the battery cell 210-1 is discharged, the capacity of the battery cell 210-1 decreases.

Likewise, the switch element 11-2 and the resistor 12-2 connected in series are connected in parallel with the battery cell 210-2. The switch element 11-3 and the resistor 12-3 connected in series are connected in parallel with the battery cell 210-3. The switch element 11-4 and the resistor 12-4 connected in series are connected in parallel with the battery cell 210-4. The switch element 11-5 and the resistor 12-5 connected in series are connected in parallel with the battery cell 210-5.

The chip beads 13-1 to 13-5 are connected between the switch elements 11-1 to 11-5 and the positive electrodes of the battery cells 210-1 to 210-5, respectively. The chip bead 13-6 is connected between the resistor 12-5 and the negative electrode of the battery cell 210-5. The chip beads 13-1 to 13-6 are inductors, and have a function of protection from current fluctuation or a function of a filter against high frequency noise.

Hereafter, the switch elements 11-1 to 11-5 are also simply referred to as “switch elements 11” unless they need to be distinguished from each other. The resistors 12-1 to 12-5 are also simply referred to as “resistors 12” unless they need to be distinguished from each other. The chip beads 13-1 to 13-6 are also simply referred to as “chip beads 13” unless they need to be distinguished from each other.

Each switch element 11 may be, for example, a semiconductor switch. The switch element 11 is controlled to be on as a result of being driven to be on by the processor 40.

The voltage detection circuit 20 detects the voltage of each of the battery cells 210-1 to 210-5. The voltage detection circuit 20 is electrically connected to the positive electrode of each of the battery cells 210-1 to 210-5. The voltage detection circuit 20 is electrically connected to the negative electrode of each of the battery cells 210-1 to 210-5.

The voltage detection circuit 20 can detect the voltage of the battery cell 210-1, based on the difference between the voltage of the wire connected to the positive electrode of the battery cell 210-1 and the voltage of the wire connected to the negative electrode of the battery cell 210-1. Likewise, the voltage detection circuit 20 can detect the voltage of each of the battery cells 210-2 to 210-5. The voltage detection circuit 20 outputs the detected voltage of each of the battery cells 210-1 to 210-5 to the processor 40.

The current detection circuit 30 detects the voltage between two points between any two adjacent battery cells 210 from among the battery cells 210-1 to 210-5 as points having the same potential, in a state in which the battery pack 200 is not charged or discharged and the cell balancing device 100 does not perform the cell balancing control of the battery pack 200. The current detection circuit 30 detects the current flowing through the battery pack 200, based on the voltage between the two points. The current detection circuit 30 outputs the detected current flowing through the battery pack 200, to the processor 40. The current detection circuit 30 detects the current based on the resistance value of a bus bar 702 (see FIG. 8), without using a shunt resistor as a component for current detection. To ensure the accuracy of current detection, the current detection circuit 30 detects the temperature around the bus bar 702, and corrects the resistance value of the bus bar 702 based on the temperature.

The current detection circuit 30 in this embodiment detects the voltage as described above, and also is supplied with drive power from the detection points. The current detection circuit 30 in this embodiment requires 4 V or more for driving. Accordingly, the current detection circuit 30 detects the voltage between two points between the battery cells 210-1 and 210-2 where a voltage of 4 V or more can be secured even in a state in which the SOC of the battery pack 200 is at its lower limit (see FIG. 1).

The detection of the voltage between the battery cells 210-1 and 210-2 by the current detection circuit 30 is an example, and the present disclosure is not limited to such. The position at which the current detection circuit 30 detects the voltage may be any points where the voltage for driving the current detection circuit 30 can be secured, as mentioned above. Hence, the current detection circuit 30 may detect the voltage between two points between other adjacent battery cells 210. Alternatively, the voltage detected by the current detection circuit 30 may be the voltage between two points between the positive electrode of the battery cell 210-1 having the highest potential in the battery pack 200 and the relay 300. Alternatively, the current detection circuit 30 may detect the voltage between two points between the negative electrode of the battery cell 210-5 having the lowest potential and the ground, in the case where the current detection circuit 30 is supplied with drive power from the VCC. That is, the position at which the current detection circuit 30 detects the voltage may be any points having the same potential in a state in which the battery pack 200 is not charged or discharged and the cell balancing device 100 does not perform the cell balancing control of the battery pack 200.

The current detection circuit 30 detects the voltage between the battery cells 210-1 and 210-2 via a chip bead 31 and the chip bead 13-2. The chip bead 31 is an inductor, and has a function of protection from current fluctuation or a function of a filter against high frequency noise, as with the chip beads 13. In this embodiment, the chip bead 13-2 is used for both the cell balancing control and the current detection.

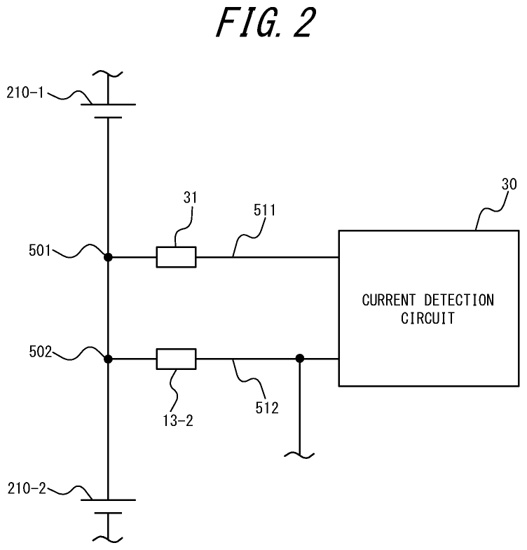

The detection of the current of the battery pack 200 by the current detection circuit 30 will be described below, with reference to FIG. 2. FIG. 2 is an enlarged diagram of the current detection circuit 30 and the battery cells 210-1 and 210-2.

As illustrated in FIG. 2, of two points on the wire connecting the battery cells 210-1 and 210-2, a first node 501 is connected to the current detection circuit 30 via a wire 511 to which the chip bead 31 is connected, and a second node 502 is connected to the current detection circuit 30 via a wire 512 to which the chip bead 13-2 is connected.

The first node 501 and the second node 502 are connected by the bus bar 702 (see FIG. 8). The bus bar 702 may be, for example, an aluminum bus bar. The resistance value of the aluminum bus bar is, for example, about 0.03 mΩ. The first node 501 and the second node 502 have the same potential in a state in which the battery pack 200 is not charged or discharged and the cell balancing device 100 does not perform the cell balancing control of the battery pack 200. In a state in which the battery pack 200 is charged or discharged, however, there is a minute voltage (e.g. about 0.8 μV) between the two points.

The current detection circuit 30 stores the resistance value of the bus bar 702 as a known value. The current detection circuit 30 calculates the current flowing through the bus bar 702, by dividing the voltage, i.e. the difference between the potential of the first node 501 and the potential of the second node 502, by the resistance value of the bus bar 702. The current flowing through the bus bar 702 is equivalent to the current flowing through the battery pack 200. Hence, by detecting the potentials of the first node 501 and the second node 502, the current detection circuit 30 can detect the current flowing through the battery pack 200.

Referring back to FIG. 1, the components in the cell balancing device 100 will be described below.

The processor 40 is communicably connected to each component in the cell balancing device 100. The processor 40 may output control instructions to each component, and acquire information from each component.

The processor 40 stores the voltage of each of the battery cells 210-1 to 210-5 acquired from the voltage detection circuit 20, in the storage unit 50. The processor 40 may store the voltage of each of the battery cells 210-1 to 210-5 when the relay 300 is off and the battery pack 200 is in an open state, in the storage unit 50.

The processor 40 stores the current flowing through the battery pack 200, which is acquired from the current detection circuit 30, in the storage unit 50.

The processor 40 controls on/off of each switch element 11. The processor 40 drives the switch element 11 to on, to discharge the battery cell 210 connected in parallel with the switch element 11. In FIG. 1, the control lines from the processor 40 to the switch elements 11-1 to 11-5 are not illustrated for simplicity's sake.

The processor 40 discharges each battery cell 210 other than the battery cell 210 lowest in voltage so that the voltage of the other battery cell 210 will be closer to the voltage of the battery cell 210 lowest in voltage, thus adjusting the capacities of the battery cells 210. The processor 40 can calculate the adjustment amount of the capacity of the other battery cell 210, based on the difference between the voltage of the battery cell 210 lowest in voltage and the voltage of the other battery cell 210. The processor 40 causes the capacity adjustment circuit 10 to adjust the capacity of the other battery cell 210, based on the calculated adjustment amount.

The processor 40 can calculate the difference between the capacity of the battery cell 210 lowest in voltage and the capacity of the other battery cell 210, with reference to a table stored in the storage unit 50 and indicating the relationship between the voltage and the capacity of each battery cell 210. The processor 40 can calculate the discharge current flowing through the battery cell 210 when the switch element 11 is turned on to discharge the battery cell 210, from the voltage of the battery cell 210 and the resistance value of the resistor 12. From the difference between the capacity of the battery cell 210 lowest in voltage and the capacity of the other battery cell 210 and the discharge current flowing through the battery cell 210 when the switch element 11 is on, the processor 40 can calculate the time for flowing the discharge current in order to adjust the capacity.

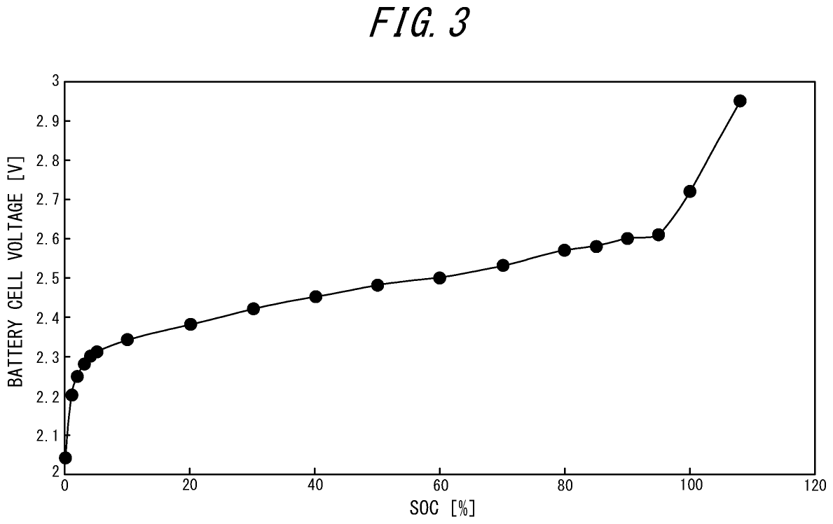

When calculating the discharge current, the processor 40 may use not the actual voltage value of the battery cell 210 but a predetermined voltage value. For example, in the case where the relationship between the voltage and the SOC of the battery cell 21 is as illustrated in FIG. 3, the voltage of the battery cell 21 fluctuates little in the range in which the SOC is about 40% to 90%. In this case, for example, the voltage value of the battery cell 21 when the SOC is 80% may be taken to be the predetermined voltage value, and the discharge current may be calculated from this voltage value and the resistance value of the resistor 12.

The processor 40 continuously outputs a P-RUN signal to the watchdog unit 60 during normal operation of the processor 40. The P-RUN signal is a signal indicating that the processor 40 is operating normally. The P-RUN signal is, for example, a pulse signal having a predetermined cycle and a duty ratio, but may be any other signal.

The processor 40 resets operation, upon receiving a reset signal from the watchdog unit 60. When the processor 40 enters an abnormal state of not operating normally, such as a freeze or a runaway, the processor 40 stops outputting the P-RUN signal. When a predetermined time elapses after the processor 40 stops outputting the P-RUN signal, the processor 40 receives the reset signal from the watchdog unit 60, so that the processor 40 can reset operation in the abnormal state.

The storage unit 50 is connected to the processor 40, and stores information acquired from the processor 40. The storage unit 50 may function as working memory of the processor 40. The storage unit 50 may store programs executed by the processor 40. For example, the storage unit 50 is composed of semiconductor memory. The storage unit 50 is, however, not limited to such, and may be composed of a magnetic storage medium or any other storage medium. The storage unit 50 may be included in the processor 40 as part of the processor 40.

The storage unit 50 may store the table indicating the relationship between the voltage and the capacity of each battery cell 210. The storage unit 50 may store a table indicating the relationship between the voltage and the SOC of each battery cell 210. Since the capacity and the SOC of the battery cell 210 are proportional to each other, if one of the capacity and the SOC is known, the processor 40 can calculate the other one of the capacity and the SOC.

The watchdog unit 60 outputs the reset signal to the processor 40, in the case where the watchdog unit 60 cannot acquire the P-RUN signal from the processor 40 for a predetermined time.

The watchdog unit 60 has a function (abnormal monitoring function) of monitoring, by receiving the P-RUN signal, whether the processor 40 is operating normally, In addition, the watchdog unit 60 monitors whether the processor 40 is in a sleep state or a normal state. The watchdog unit 60 monitors the current flowing from the VCC power source to the processor 40 and the voltage detection circuit 20. In the case where the current is less than a predetermined value, the watchdog unit 60 determines that the processor 40 is in the sleep state, stops the abnormal monitoring function, and enters power save mode while continuing the monitoring of the current from the VCC power source. Subsequently, in the case where the processor 40 returns to the normal state and the current flowing to the processor 40 becomes greater than or equal to the predetermined value, the watchdog unit 60 returns to normal mode and resumes the abnormal monitoring function.

As a result of the watchdog unit 60 stopping operation in the sleep state in this way, the current flowing to the watchdog unit 60 can be saved in a state in which the ignition is off. The predetermined value may be, for example, about 1 mA.

(Timing of Cell Balancing Control)

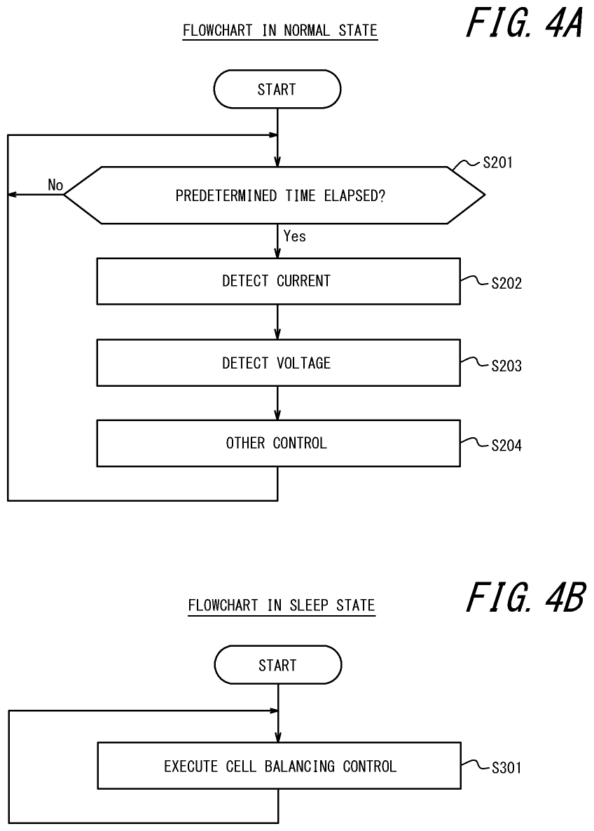

The timing of cell balancing control will be described below, with reference to FIGS. 4A and 4B. FIGS. 4A and 4B are each a flowchart illustrating an example of the timing of cell balancing control by the cell balancing device 100 according to this embodiment.

The cell balancing device 100 performs the process in the flowchart in FIG. 4A, in the normal state. The normal state is a state in which the processor 40 executes a program for detecting the temperature and/or the overvoltage of the battery pack 200 and a program for computing the SOC and/or the SOH of the battery pack 200. The cell balancing device 100 performs the process in the flowchart in FIG. 4B, in the sleep state. The sleep state is a state in which the processor 40 operates with low power. In the sleep state, the processor 40 can perform the below-described cell balancing control in a state in which the program for detecting the temperature and/or the overvoltage and the program for computing the SOC and/or the SOH are stopped. The processor 40 transitions to the sleep state after the ignition is turned off.

The process of the cell balancing device 100 in the normal state will be described below, with reference to FIG. 4A.

When the ignition is turned on, the processor 40 in the cell balancing device 100 determines whether a predetermined time has elapsed (step S201). The predetermined time may be, for example, about 10 msec. In the case where the processor 40 determines that the predetermined time has not elapsed (step S201: No), the processor 40 repeats the process in step S201.

In the case where the processor 40 determines that the predetermined time has elapsed (step S201: Yes), the processor 40 acquires the current of the battery pack 200 detected by the current detection circuit 30 (step S202). The processor 40 also acquires the voltage of each battery cell 210 detected by the voltage detection circuit 20 (step S203).

The processor 40 performs other control (step S204), and returns to the process in step S201.

The process of the cell balancing device 100 in the sleep state will be described below, with reference to FIG. 4B.

When the ignition is turned off, the processor 40 in the cell balancing device 100 executes cell balancing control (step S301).

Thus, the cell balancing device 100 according to this embodiment does not execute the cell balancing control in the normal state, and executes the cell balancing control in the sleep state. That is, the cell balancing device 100 executes the cell balancing control in the sleep state in which the current detection circuit 30 does not detect the current flowing through the battery pack 200, and does not execute the cell balancing control in the normal state in which the current detection circuit 30 detects the current flowing through the battery pack 200. Therefore, the detection of the current of the battery pack 200 by the current detection circuit 30 in the normal state is not affected by the cell balancing control. This will be described in detail below.

As a precondition, the processor 40 needs to transmit the current value of the battery pack 200 and the total voltage of the battery pack 200 to a controller in the vehicle with a predetermined cycle (e.g. 20 msec). In the case where the time constant of a CR filter in the current detection circuit 30 is high (e.g. 15 msec) for the predetermined cycle, it is difficult to perform the current detection, the voltage detection, and the cell balancing control in sequence within this predetermined cycle. For example, this problem is noticeable in the case where the time constant is ½ or more of the predetermined cycle.

The problem may be addressed by performing the cell balancing control and the current detection in parallel. However, in this embodiment, the chip bead 13-2 has current passed through it during the cell balancing control and also during the current detection by the current detection circuit 30, as illustrated in FIG. 1. Accordingly, the following problem occurs when the cell balancing control and the current detection are performed simultaneously. In a state in which such cell balancing control that discharges the battery cell 210-2 and does not discharge the battery cell 210-1 is executed, current flows through the chip bead 13-2 as a result of the discharge of the battery cell 210-2. If the voltage between the first node 501 and the second node 502 is detected in this state, the passage of current through the chip bead 13-2 causes a potential difference between the first node 501 and the second node 502. This leads to erroneous current value detection. For example, even in the case where there is no discharge from the battery pack 200, the current detection circuit 30 detects current.

That is, in current detection whereby the voltage between two points is detected and the current value is calculated, if the current detection is performed in a state in which the battery cell 210 corresponding to one of the two measurement points is discharged, the potential of the other measurement point is detected lower than the potential of the measurement point. This causes erroneous current value detection.

In the cell balancing device 100 according to this embodiment, the processor 40 prohibits the execution of the cell balancing control in the normal state in which the current detection circuit 30 needs to detect current periodically (i.e. from when the ignition is turned on to when the ignition is turned off). Then, in the sleep state (i.e. from when the ignition is turned off to when the ignition is turned on), the processor 40 causes the capacity adjustment circuit 10 to adjust the capacity of each battery cell 210. Thus, the cell balancing control by the cell balancing device 100 according to this embodiment does not affect the detection of the current of the battery pack 200 by the current detection circuit 30.

Moreover, the cell balancing device 100 according to this embodiment includes the current detection circuit 30 that detects the voltage between two points between any two adjacent battery cells 210 from among the plurality of battery cells 210 and detects the current flowing through the battery pack 200 based on the voltage between the two points. Detecting the current using such current detection circuit 30 makes it unnecessary to use a current sensor such as a Hall element, so that the cell balancing device 100 can reduce the cost of the current detection means for the battery pack 200.

(Cell Balancing Control)

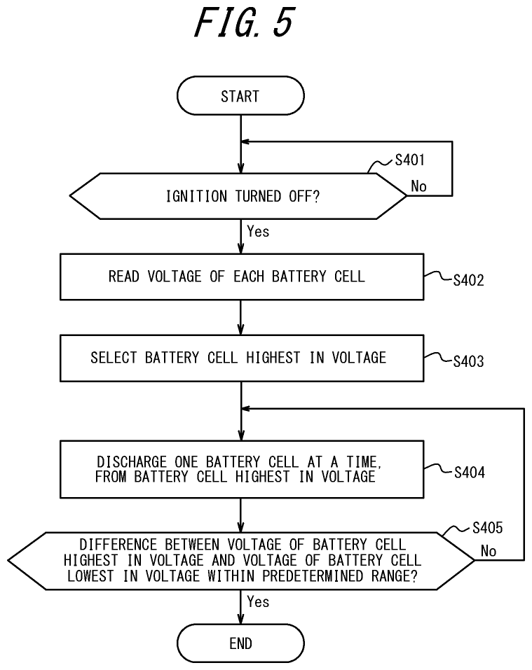

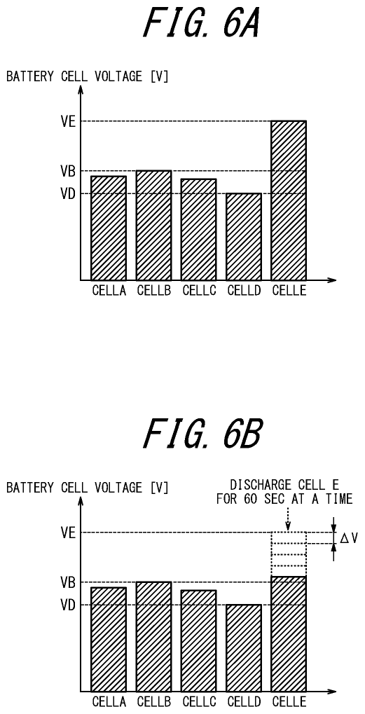

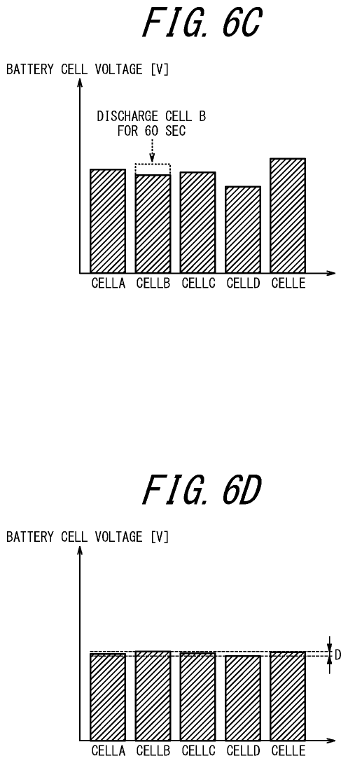

An example of the procedure of cell balancing control will be described below, with reference to FIGS. 5 and 6A to 6D.

First, an example of the procedure of cell balancing control by the cell balancing device 100 according to this embodiment will be described below, with reference to the flowchart in FIG. 5.

The processor 40 in the cell balancing device 100 monitors whether the ignition is turned off (step S401). In the case where the processor 40 determines that the ignition is not turned off (step S401: No), the processor 40 repeats the process in step S401.

In the case where the processor 40 determines that the ignition is turned off (step S401: Yes), the processor 40 starts executing the cell balancing control, and performs the processes in steps S402 to S405 in FIG. 5. In a state in which the ignition is off, the current flowing to the processor 40 is less than the predetermined value. Accordingly, the watchdog unit 60 stops the abnormal monitoring function and enters the power save mode.

The processor 40 reads the voltage of each battery cell 210 detected by the voltage detection circuit 20 and stored in the storage unit 50 when the ignition was on (step S402). In this embodiment, based on the voltage of the battery cell 210 when the ignition is on, which is close to open voltage, the processor 40 performs the cell balancing control after the ignition is turned off.

The processor 40 selects the battery cell 210 highest in voltage from among the battery cells 210-1 to 210-5 (step S403).

The processor 40 turns on the switch element 11 connected in parallel with the battery cell 210 highest in voltage, to discharge the battery cell 210 highest in voltage. The processor 40 then discharges one battery cell 210 at a time. That is, the processor 40 repeatedly performs the control of turning on only one switch element 11 without turning on two or more switch elements 11 simultaneously, to adjust the capacities of the battery cells 210-1 to 210-5 (step S404).

The processor 40 determines whether the difference between the voltage of the battery cell 210 highest in voltage and the voltage of the battery cell 210 lowest in voltage is within a predetermined range as a result of adjusting the capacities (step S405).

In the case where the processor 40 determines that the difference between the voltage of the battery cell 210 highest in voltage and the voltage of the battery cell 210 lowest in voltage is not within the predetermined range (step S405: No), the processor 40 returns to step S404 and continues the process of adjusting the capacity of each battery cell 210.

In the case where the processor 40 determines that the difference between the voltage of the battery cell 210 highest in voltage and the voltage of the battery cell 210 lowest in voltage is within the predetermined range (step S405: Yes), the processor 40 ends the cell balancing control.

As described above with regard to step S404, the processor 40 discharges only one battery cell 210 at a time in the cell balancing control. That is, the processor 40 drives only one switch element 11 at a time in the cell balancing control. Accordingly, the current flowing to the voltage detection circuit 20 is lower than in the case of simultaneously driving a plurality of switch elements 11. Hence, the current flowing to the processor 40 can be less than the predetermined value even when the cell balancing control is being performed. As a result of the current flowing to the processor 40 being less than the predetermined value, the stopped state of the watchdog unit 60 can be maintained, and consequently the sleep state of the processor 40 can be maintained. Thus, the cell balancing device 100 can execute the cell balancing control when the ignition is turned off, in a state in which the current flowing to the watchdog unit 60 and the processor 40 is saved.

This will be described in detail below. As mentioned earlier, the watchdog unit 60 monitors the current flowing to the processor 40, and determines whether the processor 40 is in the normal state or the sleep state. In the case where the processor 40 performs the cell balancing control in the sleep state after the ignition is turned off, if the processor 40 drives a plurality of switch elements 11 and the current flowing to the processor 40 becomes greater than or equal to the predetermined value, the watchdog unit 60 returns to the normal mode and resumes the abnormal monitoring function. Here, since the processor 40 is in the sleep state and has stopped the transmission of the P-RUN signal, the watchdog unit 60 determines that the processor 40 is abnormal, and resets and restarts the processor 40. This causes an increase in the current consumption of the processor 40.

In this embodiment, by performing the cell balancing control so that the current flowing to the processor 40 will remain less than the predetermined value, the reset of the processor 40 can be prevented to thus prevent an increase in the power consumption of the processor 40.

Although the above describes the case where the processor 40 discharges only one battery cell 210 in the cell balancing control, the number of battery cells 210 discharged simultaneously is not limited to one. For example, in the case where the current flowing to the processor 40 is less than the predetermined value even when a predetermined number of battery cells 210 are discharged simultaneously, the processor 40 may discharge the predetermined number of battery cells 210 simultaneously.

An example of the procedure of cell balancing control by the cell balancing device 100 according to this embodiment will be described in more detail below, with reference to FIGS. 6A to 6D. Cells A to E illustrated in FIGS. 6A to 6D respectively correspond to the battery cells 210-1 to 210-5 illustrated in FIG. 1.

When the ignition is turned off, the processor 40 in the cell balancing device 100 reads the respective voltages of the cells A to E stored in the storage unit 50 when the ignition was on. FIG. 6A illustrates an example of the respective voltages of the cells A to E read by the processor 40.

In the example illustrated in FIG. 6A, the voltage VE of the cell E is the highest voltage from among the respective voltages of the cells A to E, the voltage VD of the cell D is the lowest voltage from among the respective voltages of the cells A to E, and the voltage VB of the cell B is the second highest voltage from among the respective voltages of the cells A to E.

The processor 40 selects the cell E highest in voltage, and first discharges the cell E for a predetermined period. The predetermined period is set beforehand, and may be, for example, about 60 sec. As a result of the cell E being discharged for the predetermined period, the voltage of the cell E decreases by ΔV, as illustrated in FIG. 6B. After discharging the cell E for the predetermined period, the processor 40 determines whether discharging the cell E for the predetermined period next will cause the voltage of the cell E to fall below the voltage of the cell B second highest in voltage.

In the case where discharging the cell E for the predetermined period next will not cause the voltage of the cell E to fall below the voltage of the cell B, the processor 40 repeats discharging the cell E for the predetermined period. FIG. 6B illustrates a state in which the control of discharging the cell E for the predetermined period (60 sec) has been performed four times.

In the state illustrated in FIG. 6B, if the cell E is discharged for the predetermined period next, the voltage of the cell E will fall below the voltage of the cell B. In this case, the processor 40 discharges the cell B highest in voltage next to the cell E, for the predetermined period. FIG. 6C illustrates a state in which the cell B has been discharged for the predetermined period.

Subsequently, the same process is repeatedly performed. Once the respective voltages of the cells A to E have come within a predetermined range, the processor 40 ends the cell balancing control. The predetermined range may be the range of the voltage by which each of the cells A to E decreases in voltage when discharged for the predetermined period once, i.e. the range of ΔV illustrated in FIG. 6B.

FIG. 6D illustrates an example of the respective voltages of the cells A to E when the cell balancing control ends. In the example illustrated in FIG. 6D, the respective voltages of the cells A to E are within a range D. The range D is within the range of ΔV illustrated in FIG. 6B.

In the process illustrated in FIGS. 6A to 6D, in the case where a plurality of battery cells 210 are equal in voltage, for example, the processor 40 may preferentially discharge a battery cell 210 having a lower number (in the example illustrated in FIG. 1, preferentially discharge a battery cell 210 on the battery cell 210-1 side).

In the cell balancing device 100 according to this embodiment, when the processor 40 causes the capacity adjustment circuit 10 to adjust the capacity of each battery cell 210 while the ignition of the vehicle is off, the processor 40 limits the number of simultaneously discharged battery cells 210 to the predetermined number so that the current flowing to the processor 40 is less than the predetermined value. Thus, the state when the operation of the watchdog unit 60 is stopped can be maintained, and consequently the sleep state of the processor 40 can be maintained. In this way, the cell balancing device 100 according to this embodiment can execute the cell balancing control when the ignition is off, in a state in which the current flowing to the watchdog unit 60 and the processor 40 is saved.

For example, JP 2006-164882 A discloses a capacity adjustment device that groups battery cells and performs cell balancing control for each group. In the case where cell balancing control is performed by this method when the ignition is off, if the ignition is turned on before the completion of the cell balancing control, the vehicle may start in a state in which the voltage difference between the battery cells is large. The cell balancing device 100 according to this embodiment, on the other hand, first discharges the battery cell 210 highest in voltage, so that the voltage difference between the battery cells 210 is small even if the ignition is turned on before the completion of the cell balancing control.

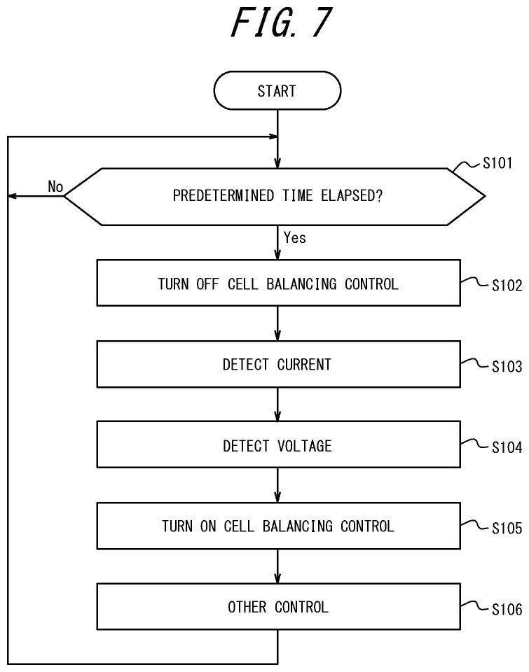

The foregoing embodiment describes the structure in which cell balancing control is performed after the ignition is turned off. However, if the time constant of the CR filter in the current detection circuit 30 is sufficiently small (e.g. 5 msec) and the processor 40 can perform current detection and cell balancing control in sequence in the predetermined cycle (e.g. 20 msec), the cell balancing device 100 may perform the procedure in the order illustrated in FIG. 7. The procedure in the flowchart in FIG. 7 will be described below.

When the ignition is turned on, the cell balancing device 100 determines whether the predetermined time has elapsed (step S101).

In the case where the cell balancing device 100 determines that the predetermined time has elapsed (step S101: Yes), the cell balancing device 100 turns off the cell balancing control (step S102).

The cell balancing device 100 detects the current flowing through the battery pack 200 (step S103). The cell balancing device 100 detects the voltage of each battery cell 210 included in the battery pack 200 (step S104).

The cell balancing device 100 turns on the cell balancing control, and executes the cell balancing control (step S105). The period of the cell balancing control in FIG. 7 is a short time (e.g. 5 msec to 10 msec) that is within the foregoing predetermined cycle. After the predetermined time elapses, the cell balancing device 100 turns off the cell balancing control in step S102. That is, in the cell balancing control in FIG. 7, discharge is performed little by little while the vehicle is running, instead of performing discharge over time after the ignition is turned off. The order of cell voltage discharge in this example is descending order of cell voltage, as illustrated in FIGS. 6A to 6D.

The battery pack 200 in this embodiment is contained in a case 600, as illustrated in FIG. 8. In FIG. 8, the positions of the battery cells 210-1 to 210-5 are designated by the dotted-line boxes. A bus bar 701 connects a bus bar connected to the relay 300 and the positive electrode of the battery cell 210-1. The bus bar 702 connects the battery cells 210-1 and 210-2. A bus bar 703 connects the battery cells 210-2 and 210-3. A bus bar 704 connects the battery cells 210-3 and 210-4. A bus bar 705 connects the battery cells 210-4 and 210-5. A bus bar 706 connects the battery cell 210-5 and the ground.

The bus bar 701 has a terminal 701a for detecting the cell voltage of the battery cell 210-1 and serving as a discharge route in cell balancing control. The bus bar 702 has terminals 702a and 702b similar to the terminal 701a. The bus bar 703 has terminals 703a and 703b similar to the terminal 701a. The bus bar 704 has terminals 704a and 704b similar to the terminal 701a. The bus bar 705 has terminals 705a and 705b similar to the terminal 701a. The bus bar 706 has a terminal 706b similar to the terminal 701a. [0096] In this embodiment, the first node 501 is the terminal 702b, and the second node 502 is the terminal 702a. Thus, the terminals 702a and 70b also function as terminals for detecting the voltage in the current detection circuit 30.

Although one of the disclosed embodiments has been described by way of the drawings and examples, various changes and modifications may be easily made by those of ordinary skill in the art based on the present disclosure. For example, although the current of the battery pack 200 is detected by measuring the voltage between two points of the same bus bar in this embodiment, in the case where the battery cells 210 are laminate cell type and are connected in series by direct contact with an electrode tab, the voltage between two points of one electrode tab may be detected. Thus, the voltage detection location is not limited to a bus bar, and may be a wire including an electrode tab.

Such changes and modifications are therefore included in the scope of the present disclosure. For example, the functions included in the means may be rearranged without logical inconsistency, and a plurality of means may be combined into one means and a means may be divided into a plurality of means.

### REFERENCE SIGNS LIST

100 cell balancing device

1 battery device

10 capacity adjustment circuit

11 switch element (SW)

12 resistor

13 chip bead

20 voltage detection circuit

30 current detection circuit

31 chip bead

40 processor

50 storage unit

60 watchdog unit

200 battery pack

210 battery cell

300 relay

301, 302 relay

400 load

501 first node

502 second node

511 wire

512 wire

600 case

701, 702, 703, 704, 705, 706 bus bar

701a to 705a terminal

702b to 706b terminal

1. A cell balancing device that performs cell balancing control for a battery pack including a plurality of battery cells connected in series, the cell balancing device comprising:
a capacity adjustment circuit including a plurality of pairs of series-connected switch elements and resistors that are connected in parallel with the respective plurality of battery cells, and configured to discharge the battery cells to adjust respective capacities of the battery cells;
a processor configured to control the switch elements; and
a watchdog unit configured to monitor the processor and, in the case where the processor is abnormal, reset the processor, and stop monitoring the processor in the case where a current flowing to the processor is less than a predetermined value,
wherein the processor is configured to transition to a sleep state when an ignition of a vehicle having the cell balancing device installed therein is turned off, and, in the sleep state, control the switch elements to adjust the respective capacities of the battery cells, and
the processor is configured to, when adjusting the respective capacities of the battery cells, limit the number of simultaneously discharged battery cells to a predetermined number so that the current flowing to the processor is less than the predetermined value.

2. The cell balancing device according to claim 1, wherein the processor is configured to discharge one battery cell at a time, when adjusting the respective capacities of the battery cells.

3. The cell balancing device according to claim 1, wherein the processor is configured to discharge a battery cell highest in voltage first, when adjusting the respective capacities of the battery cells.

4. The cell balancing device according to claim 3, wherein the processor is configured to discharge the battery cell for a predetermined period at a time, when adjusting the respective capacities of the battery cells.

5. The cell balancing device according to claim 4, wherein the processor is configured to, after discharging the battery cell for the predetermined period, in the case where discharging the battery cell for the predetermined period again following the discharging will cause the voltage of the battery cell to fall below a voltage of a battery cell second highest in voltage, discharge the battery cell second highest in voltage for the predetermined period.
